(19) United States
(12) Patent Application Publication
(10) Pub. No.: US 2025/0190631 A1
(43) Pub. Date: Jun. 12, 2025

(54) SYSTEM AND METHOD FOR VERIFYING DATA TRANSMISSION

(71) Applicant: Samsung Electronics Co., Ltd., Suwon-si (KR)

(72) Inventor: Ronald MINNICH, Livermore, CA (US)

(21) Appl. No.: 18/731,212

(22) Filed: May 31, 2024

Related U.S. Application Data
(60) Provisional application No. 63/609,258, filed on Dec. 12, 2023.

(51) Int. Cl. G06F 21/78; G06F 21/85

(52) U.S. Cl. CPC G06F 21/78; G06F 21/85

(57) ABSTRACT

A system and method for verifying data transmission. In some embodiments, a system includes: a memory, and a hashing circuit, wherein the hashing circuit is configured to calculate a hash value based on a received data set, the received data set being included in one or more received memory write commands.

### CROSS-REFERENCE TO RELATED APPLICATION(S)

The present application claims priority to and the benefit of U.S. Provisional Application No. 63/609,258, filed Dec. 12, 2023, entitled “WRITE-MEASURING SPI RAM: PROVIDING ASSURANCE THAT WHAT WAS WRITTEN IS WHAT WAS INTENDED”, the entire content of which is incorporated herein by reference.

### FIELD

One or more aspects of embodiments according to the present disclosure relate to digital circuits, and more particularly to a system and method for verifying data transmission.

### BACKGROUND

In various circumstances, digital circuits may communicate with each other. For example, in a computing system containing a baseboard management controller, a plurality of computing circuits, and a plurality of memories for storing boot-up instructions for the computing circuits, the baseboard management controller may send the boot-up instructions to the memories at start-up.

It is with respect to this general technical environment that aspects of the present disclosure are related.

### SUMMARY

According to an embodiment of the present disclosure, there is provided a system, including: a memory, and a hashing circuit, wherein the hashing circuit is configured to calculate a hash value based on a received data set, the received data set being included in one or more received memory write commands.

In some embodiments, the hashing circuit is further configured to store the hash value in one or more memory-mapped locations.

In some embodiments, the memory-mapped locations are one or more memory-mapped registers in the hashing circuit.

In some embodiments, the memory-mapped locations are one or more memory locations in the memory.

In some embodiments, the hash value is further based on an initial value stored in the one or more memory-mapped locations.

In some embodiments, the one or more memory-mapped locations are externally read-only.

In some embodiments, the system includes a Serial Peripheral Interface memory module including the memory and the hashing circuit.

In some embodiments, the system includes: a printed circuit board; a baseboard management controller on the printed circuit board; and a plurality of Serial Peripheral Interface memory modules, including the Serial Peripheral Interface memory module, on the printed circuit board, wherein the baseboard management controller is configured: to send the one or more write commands, including a transmitted data set, to the Serial Peripheral Interface memory module, to calculate a comparison value based on the transmitted data set, to read the hash value from the one or more memory-mapped locations, and to compare the hash value and the comparison value.

In some embodiments: the baseboard management controller is further configured: to read an initial value from the one or more memory-mapped locations before sending the one or more write commands; and to calculate a comparison value further based on the initial value.

In some embodiments, the system further includes a plurality of computing circuits on the printed circuit board, each computing circuit being: connected to a respective Serial Peripheral Interface memory module of the Serial Peripheral Interface memory modules, and configured to read instructions from the respective Serial Peripheral Interface memory module.

In some embodiments, the memory and the hashing circuit are part of a single semiconductor chip.

In some embodiments, the hashing circuit includes a linear feedback shift register.

In some embodiments, the received data set includes an address for each write operation and a value for each write operation.

According to an embodiment of the present disclosure, there is provided a method, including: calculating, by a hashing circuit connected to a memory, a hash value based on a received data set, the received data set being included in one or more received memory write commands.

In some embodiments, the method further includes storing the hash value in one or more memory-mapped locations.

In some embodiments, the memory-mapped locations are one or more memory-mapped registers in the hashing circuit.

In some embodiments, the memory-mapped locations are one or more memory locations in the memory.

In some embodiments, the hash value is further based on an initial value stored in the one or more memory-mapped locations.

In some embodiments, the one or more memory-mapped locations are externally read-only.

According to an embodiment of the present disclosure, there is provided a system, including: a memory, and a means for hashing, wherein the means for hashing is configured to calculate a hash value based on a received data set, the received data set being included in one or more received memory write commands.

### BRIEF DESCRIPTION OF THE DRAWINGS

These and other features and advantages of the present disclosure will be appreciated and understood with reference to the specification, claims, and appended drawings wherein:

FIG. 1A is a system-level diagram of a system including a host and a plurality of computing boards, each comprising a baseboard management controller and a plurality of memories for storing boot-up instructions for the computing circuits, according to an embodiment of the present disclosure;

FIG. 1B is a diagram of a one of the computing boards of FIG. 1A, including a baseboard management controller, a plurality of computing circuits, and a plurality of memories for storing boot-up instructions for the computing circuits, according to an embodiment of the present disclosure;

FIG. 2A is a block diagram of a parallel set of serial connections between a baseboard management controller and a plurality of memories, according to an embodiment of the present disclosure;

FIG. 2B is a block diagram of a daisy-chained set of serial connections between a baseboard management controller and a plurality of memories, according to an embodiment of the present disclosure;

FIG. 3 is a block diagram of a serial bus and a memory, according to an embodiment of the present disclosure; and

FIG. 4 is a flow chart, according to an embodiment of the present disclosure.

### DETAILED DESCRIPTION

The detailed description set forth below in connection with the appended drawings is intended as a description of exemplary embodiments of a system and method for verifying data transmission provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

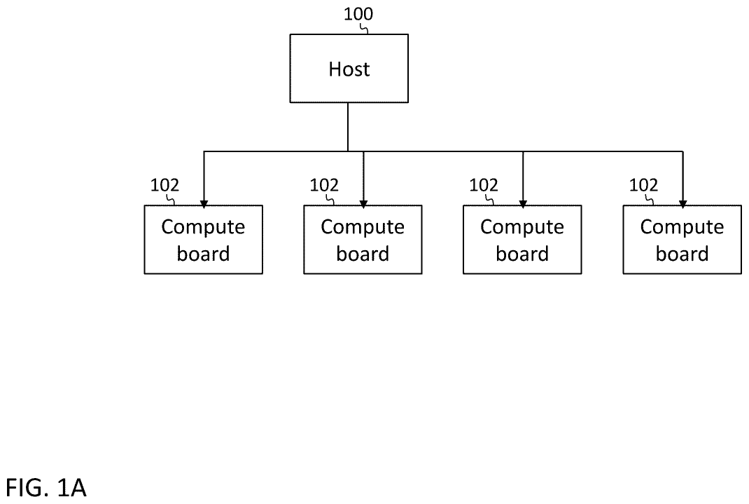

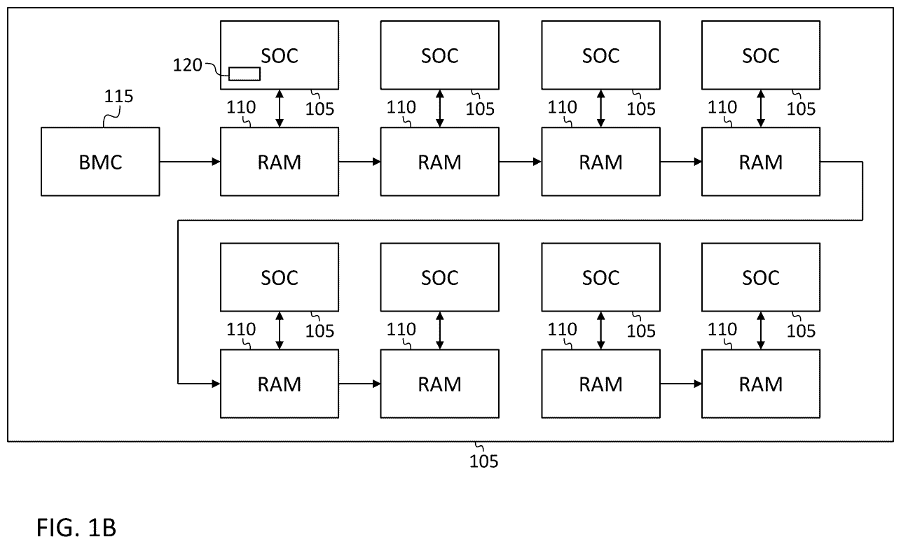

FIG. 1A shows a computing system including a host 100 and a plurality of compute boards 102, connected to the host 100 and configured to provide computing resources to the host 100. Each of the compute boards 102 may (as discussed in further detail below) include a plurality of computing circuits, and other resources, such as memory, and one or more network connections. In operation, the host 100 may be responsible for the performance of a substantial computing task, such as the training of a neural network, or such as performing finite element analysis to find solutions for a set of partial differential equations subject to specified initial conditions and boundary conditions.

To perform the computing task, the host 100 may divide the computing task into sub-tasks, and the host 100 may delegate the sub-tasks to the compute boards 102. The sub-tasks may, for example be partially independent. For example, the solution of a set of partial differential equations within a volume of interest may involve dividing the volume into portions (the finite elements) and solving the partial differential equations within each finite element, during a sequence of consecutive intervals of time (referred to as time steps), one interval at a time. Within any time step, it may be possible to find a local solution within each finite element independently of the solutions being calculated within other finite elements. As such, the solution within each finite element may be found by a respective computing circuit, and, at the end of each time step, the computing circuits may exchange the solutions they have found, as inputs that may influence the solution during the next time step.

The connections between the host 100 and the compute boards 102 may, for example, be network connections (e.g., ethernet connections) which may be carried by wires or fiber optic cables. One or more switches or hubs may be used to route data between the host 100 and the compute boards 102. In some embodiments, instead of the host 100 and the compute boards 102 being connected together by a network as shown, each of the compute boards 102 is connected to the host by a dedicated point-to-point connection. Such a point-to-point connection may be ethernet or it may be a connection complying with a different protocol, e.g., it may be Universal Serial Bus (USB), or Peripheral Component Interconnect express (PCIe), or Compute Express Link (CXL).

In various types of computing systems, it may be advantageous to write data to a memory and to have a capability to confirm that the data has been written correctly. For example, FIG. 1B shows a computing system with a plurality of SOC chips 105, each SOC chip 105 being a system on a chip, including, for example, a computing circuit (e.g., a processing circuit such as a central processing unit (CPU)) and other elements such as on-chip memory that may operate as a cache or buffer, processing accelerators, or the like. Each SOC chip 105 may be connected to a random access memory (RAM) 110 (e.g., static RAM (SRAM), dynamic RAM (DRAM), pseudo-static RAM (PSRAM) or ferroelectric RAM (F-RAM)), from which the SOC chip 105 may read boot instructions at boot-up. RAMs 110 may be employed, instead of, e.g., flash memory chips, to improve the resistance of the computing system to persistent exploits.

The RAM 110 may be connected to a baseboard management controller (BMC) 115 which may be a trusted element (e.g., it may be designed to be resistant to exploits) and which may write the boot-up instructions into the RAMs 110 after the baseboard management controller 115 starts up and before the SOC chips 105 start up. The baseboard management controller 115, the SOC chips 105, and the associated RAMs 110 may all be installed on (e.g., soldered to) a printed circuit board. FIG. 1B shows eight SOC chips 105, each with an associated RAM 110; in some embodiments more or fewer SOC chips 105 are present (e.g., 32 SOC chips 105 may be present), each with an associated RAM 110.

Each of the RAMs 110 may be connected to the baseboard management controller 115 through a serial connection, e.g., a Serial Peripheral Interface connection such as a Quad Serial Peripheral Interface (QSPI) connection (and each RAM 110 may accordingly be referred to as a Serial Peripheral Interface module or as a Quad Serial Peripheral Interface module). This connection may be employed to program the RAM 110 (e.g., to write the boot-up instructions into the RAM 110). Each RAM 110 may also be connected to the corresponding SOC chip 105 by a QSPI connection, or by a different connection (e.g., a connection with greater bandwidth). The connection may be a daisy-chained connection, as illustrated in FIG. 1B, in which the serial data transmitted by the baseboard management controller 115 may be forwarded by one or more of the RAMs 110 until the data is received by the RAM 110 for which it is intended; this RAM 110 may then store the received data instead of shifting it out through its serial output.

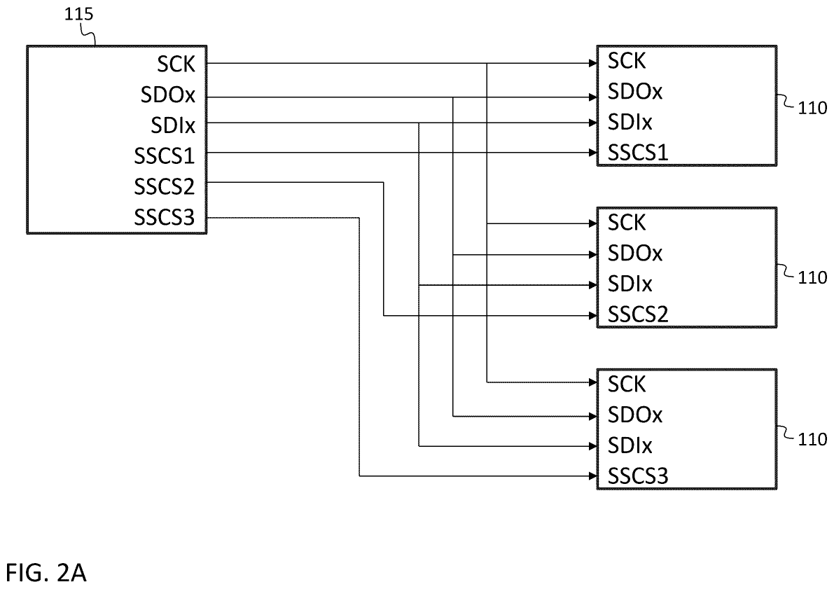

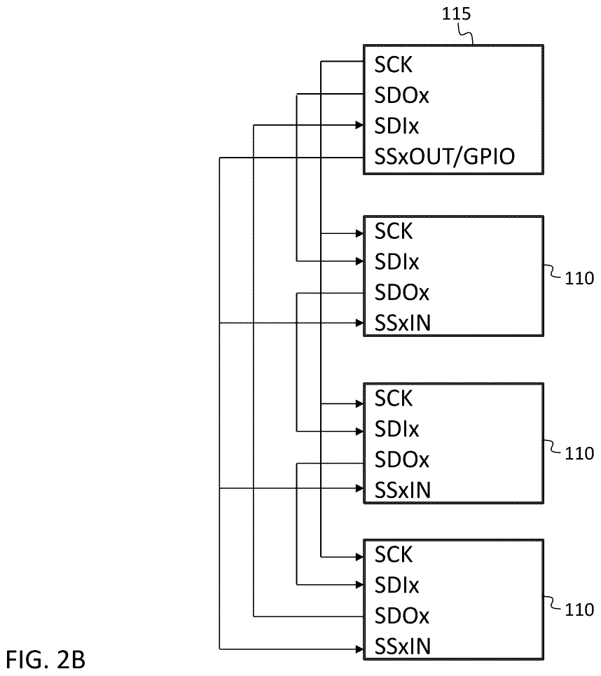

In some embodiments, each RAM 110 is programmed with the same data, which may be broadcast to all of the RAMs 110; in such an embodiment the programming may be performed for all of the RAMs 110 at the same time. For example, in the embodiment of FIG. 1B, each of the RAMs 110 may be configured both to store the received data values and to forward the data to the next RAM 110 in the daisy chain. In another configuration for broadcasting the data, illustrated in FIG. 2A, a bus (e.g., a QSPI bus, as illustrated) may be connected to the baseboard management controller 115 and to the RAMs 110 and the data may be transmitted to all of the RAMs 110 simultaneously, e.g., in parallel. The signals employed by the baseboard management controller 115 to communicate with the RAMs 110 may include a serial clock (SCK), a plurality of (e.g., four) serial data out (SDOx) signals, a plurality of (e.g., four) serial data in (SDIx) signals, and a plurality of slave select chip select signals (SSCS1, SSCS2, etc.), of which there may be one per RAM 110 as shown. In FIG. 2A, clock, data out, and data in lines are common. Chips are individually enabled by the SSCS lines for read and write. On write, all SSCS lines may be concurrently selected for broadcast.

FIG. 2B shows, in greater detail than FIG. 1B, the QSPI connections between the baseboard management controller 115 and the RAMs 110, when the QSPI connections are configured in a daisy-chained arrangement. In some embodiments, as in the embodiment of FIG. 2A, each RAM 110 is programmed with the same data, which may be broadcast to all of the RAMs 110. For example, as mentioned above, in the embodiment of FIG. 1B (and of FIG. 2B), each of the RAMs 110 may be configured both to store the received data values and to forward the data to the next RAM 110 in the daisy chain. The signals employed by the baseboard management controller 115 to communicate with the RAMs 110 may include a serial clock (SCK), a serial data out (SDOx) signal, a serial data in (SDIx) signal, and a slave select chip select signal (SSxOUT/GPIO), which may be broadcast to all of the RAMs 110 in parallel, as shown. In FIG. 2B, the clock lines are also common (in addition to SSxOUT/GPIO). In some embodiments according to FIG. 2B, a separate respective chip select line is connected from the baseboard management controller 115 to each of the RAMs 110. These separate chip select lines may be used to read out the respective hash values from one RAM 110 at a time. In other embodiments, the chip select line is common to all of the RAMs 110 in the daisy chain. In such an embodiment, when the hash values are read out, they may be received by the baseboard management controller 115 in concatenated form, with the baseboard management controller 115 receiving (i) first, the hash value from the RAM 110 having a serial output connection connected to the serial input connection of the baseboard management controller 115, then (ii) the hash value from the next RAM 110 in the daisy chain, and so on.

The data transmitted by the baseboard management controller 115 to the RAMs 110 may include (e.g., consist of) address-value pairs, and each of the RAMs 110, upon receiving such an address-value pair, may store the value of the address-value pair in the memory of the RAM 110 at the address of the address-value pair. When a RAM 110 is programmed at startup errors may occur in the transmission of the data (e.g., of the boot-up instructions) from the baseboard management controller 115 to the RAM 110. Such errors may be due to manufacturing imperfections in the printed circuit board or in components (e.g., series resistors) on the printed circuit board. As such, the likelihood of data errors occurring may vary from board to board, and it may also vary depending on the data pattern transmitted. For example, in a first board, a particular data pattern may frequently generate one or more errors during transmission from the baseboard management controller 115 to one the RAMs 110, whereas a different data pattern may not generate such errors in the first board, and the same data pattern may not generate such errors when transmitted in another board.

Such errors may to some extent be detected by reading back, by the baseboard management controller 115, from the RAMs 110, the data that was written to the RAMs 110, to confirm that the data was received without errors. This approach, however, may be time consuming. For example, in a system with 32 SOC chips 105 and 32 associated RAMs 110, the time required to read back the data, from one RAM 110 at a time, may be 32 times as great as the time to program all of the RAMs 110 concurrently with a single data broadcast. Moreover, to the extent that transmission of data between the baseboard management controller 115 and the RAMs 110 is not perfectly reliable, the risk of errors on readback (which may indicate, incorrectly, that the data was not stored correctly, resulting in unnecessary remedial action) may be significant.

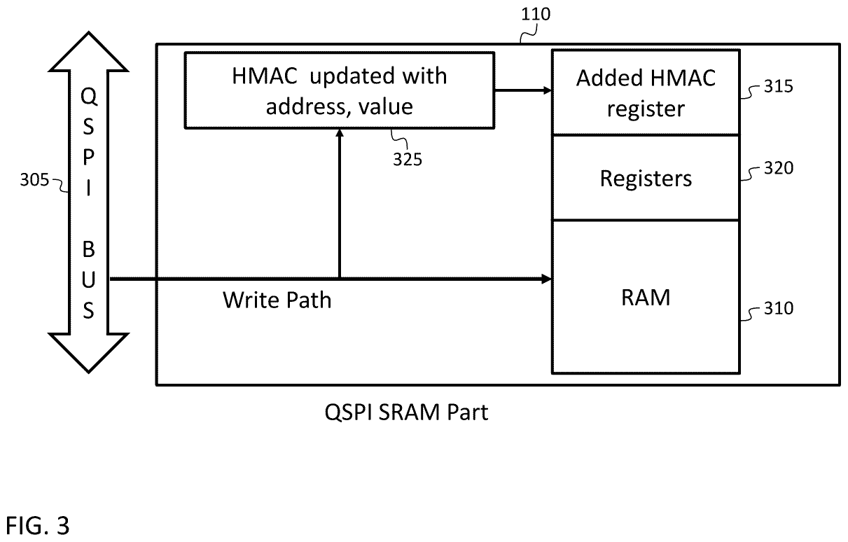

In some embodiments, therefore, hash values are used to verify error-free reception of the data by the RAMs 110. Referring again to FIG. 1B, each of the RAMs 110 may include one or more registers 320 (FIG. 3; e.g., one or more 8-bit registers, which may be referred to as hash value registers) for storing a hash value (several registers may be used if the hash value is too long to fit in one register). When the RAM 110 is being programmed, all of the data it receives (which may be referred to as a received data set, the received data set corresponding to (and, in the absence of errors, being equal to) a transmitted data set transmitted by the baseboard management controller) may be hashed into a single hash value, e.g., by a hashing circuit 120 (FIG. 1B; the hashing circuit 120 is shown in only one of the RAMs 110; in some embodiments, a hashing circuit 120 may be present in several or all of the RAMs 110). The baseboard management controller 115 may also calculate a hash value, which may be referred to as a comparison value, using the transmitted data and the same hashing algorithm. The baseboard management controller 115 may then, after programming the RAMs 110, read the hashed values, and compare them to the respective comparison values (or to the comparison value, if the comparison values for all of the RAMs 110 are the same) and, for each such comparison conclude that (i) if the hash value read from the hash value registers of the RAM 110 matches the comparison value, the data was written without errors, or (ii) if the hash value read from the hash value registers of the RAM 110 does not match the comparison value the data was not written without errors. If the data was not written without errors, the baseboard management controller 115 may perform additional testing or troubleshooting and (either immediately or after performing additional testing or troubleshooting) report the fault to a higher-level management system (e.g., to a host that is connected to the computing system, or to a human operator (e.g., via a display, or via an automated email report, or via an automated short message system (SMS) report)). A computing system that exhibits such a fault may (either immediately, or after further testing) be taken out of service and scrapped.

In embodiments in which the values stored in the hash value registers of the RAMs 110 before data transmission begins are not known by the baseboard management controller 115 (e.g., because they do not reset (or are not reset, by the RAMs 110) at power-up to a preset value (e.g., all zeros)), the baseboard management controller 115 may read the initial value of each of the hash value registers before beginning the data transmission, and calculate each comparison value, using the hashing algorithm, based on the initial value and on the transmitted data.

In some embodiments, the calculating of the hash value is performed in each of the RAMs 110 by a circuit which is part of the RAM 110 (e.g., which is fabricated on the same semiconductor chip (e.g., the same silicon chip) as the memory cells of the RAM 110). Such a circuit may include a linear-feedback shift register the input to which is formed as the exclusive-OR of (i) one or more other bit positions of the shift register and (ii) an input value (e.g., a bit of the serial data received from the baseboard management controller 115). If the data rate of the data received from the baseboard management controller 115 is sufficiently high to render impractical the operation of a shift register at a clock speed equal to the data rate (which, because of the four parallel data paths in QSPI, may be four times the serial clock frequency for QSPI), then (i) a digital circuit performing an equivalent computation at a lower clock rate may be employed, or (ii) a separate set of hash value registers may be implemented for each of the parallel data streams.

The hash value registers of a RAM 110 may be memory-mapped locations; for example, they may be memory-mapped locations in the memory (e.g., part of the array of memory cells) of the RAM 110 (e.g., their locations may be memory locations of the RAM 110) or they may be separate memory-mapped registers (e.g., implemented with sets of flip-flops) on the same semiconductor chip as the RAM 110. The hash value registers of each RAM 110 may be externally read-only (e.g., not writeable by the baseboard management controller 115 nor by the SOC chip 105 associated with the RAM 110).

Although some embodiments described herein include a plurality of QSPI RAMs 110, the invention is not limited to such embodiments, and in other embodiments analogous circuits and methods may be used to verify correct reception of data by any kind of memory device (e.g., a static random access memory (SRAM) module or a dynamic random access memory (DRAM) module) or storage device (e.g., a hard drive or a solid state drive (SSD)). Moreover, in some embodiments, a comparison between (i) a value stored in hash value registers of a device (e.g., of a memory or storage device) and (ii) a comparison value calculated by a host (such as the baseboard management controller 115) may be used to verify that data read from the device has been correctly transmitted back to the host (in addition to, or instead of, verifying that data transmitted to the device has been correctly received by the device).

FIG. 3 shows a RAM 110 connected to a QSPI bus 305, in some embodiments. The address space of the RAM 110 includes a first range of addresses 310 that are mapped to the memory of the RAM 110, a second range of addresses 315 that are mapped to the hash value registers, and a third range of addresses 320 that are mapped to other registers (e.g., control and status registers) of the RAM 110. A hash value calculating circuit 325 is configured to calculate an updated hash value as address-value pairs are received, and store the updated hash value in the hash value registers (or, equivalently, the hash value registers may be part of the hash value calculating circuit 325; for example, a set of flip-flops may be configured to operate both as (i) a linear-feedback shift register for calculating the hash value and (ii) the set of (memory mapped) hash value registers storing the hash value).

As mentioned above, in some embodiments, a system may include: a memory, and a hashing circuit, wherein the hashing circuit is configured to calculate a hash value based on a received data set, the received data set being included in one or more received memory write commands. In some embodiments, the hashing circuit is further configured to store the hash value in one or more memory-mapped locations. In some embodiments, the memory-mapped locations are one or more memory-mapped registers in the hashing circuit. In some embodiments, the memory-mapped locations are one or more memory locations in the memory. In some embodiments, the hash value is further based on an initial value stored in the one or more memory-mapped locations. In some embodiments, the one or more memory-mapped locations are externally read-only. In some embodiments, the system includes a Serial Peripheral Interface memory module including the memory and the hashing circuit.

In some embodiments, the system includes: a printed circuit board; a baseboard management controller on the printed circuit board; and a plurality of Serial Peripheral Interface memory modules, including the Serial Peripheral Interface memory module, on the printed circuit board, and the baseboard management controller is configured: to send the one or more write commands, including a transmitted data set, to the Serial Peripheral Interface memory module, to calculate a comparison value based on the transmitted data set, to read the hash value from the one or more memory-mapped locations, and to compare the hash value and the comparison value.

In some embodiments: the baseboard management controller is further configured: to read an initial value from the one or more memory-mapped locations before sending the one or more write commands; and to calculate a comparison value further based on the initial value. In some embodiments, the system further includes a plurality of computing circuits on the printed circuit board, each computing circuit being: connected to a respective Serial Peripheral Interface memory module of the Serial Peripheral Interface memory modules, and configured to read instructions from the respective Serial Peripheral Interface memory module. In some embodiments, the memory and the hashing circuit are part of a single semiconductor chip. In some embodiments, the hashing circuit includes a linear feedback shift register. In some embodiments, the received data set includes an address for each write operation and a value for each write operation. In related embodiments, a system may include: a memory, and a means for hashing, wherein the means for hashing is configured to calculate a hash value based on a received data set, the received data set being included in one or more received memory write commands.

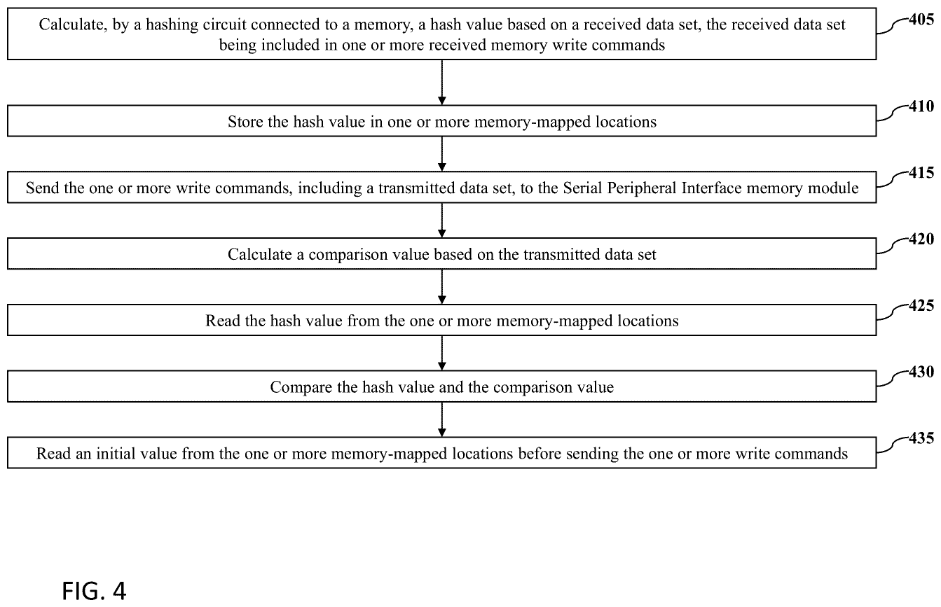

FIG. 4 shows a method of verifying data transmission to a memory, in some embodiments. Although FIG. 4 illustrates various operations in a method of verifying data transmission in a memory, embodiments according to the present disclosure are not limited thereto. For example, according to some embodiments, a method of verifying data transmission in a memory may include addition operations or fewer operations, or the order of operations may vary (unless otherwise explicitly stated or implied) without departing from the spirit and scope of embodiments according to the present disclosure. Moreover, the steps illustrated in FIG. 4 need not be performed in the order in which they are shown or discussed herein.

According to some embodiments, in a method of verifying data transmission in a memory, a hashing circuit connected to a memory receives a data set included in one or more memory write commands. For example, as discussed above with respect to FIG. 1B, a hashing circuit in a RAM 110 may calculate, at 405, a hash value based on the received data set, the received data set being included in one or more received memory write commands. The method may further include, as discussed above in the context of FIG. 3, storing, at 410, the hash value in one or more memory-mapped locations. The method may further include, as discussed above in the context of FIG. 1B, sending, at 415, by a baseboard management controller 115, the one or more write commands, including a transmitted data set, to a Serial Peripheral Interface memory module; calculating, at 420, a comparison value based on the transmitted data set; reading, at 425, the hash value from the one or more memory-mapped locations; comparing, at 430, the hash value and the comparison value; and reading, at 435, an initial value from the one or more memory-mapped locations before sending the one or more write commands. The calculating of the comparison value may be further based on the initial value.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although exemplary embodiments of a system and method for verifying data transmission have been specifically described and illustrated herein, many modifications and variations will be apparent to those skilled in the art. Accordingly, it is to be understood that a system and method for verifying data transmission constructed according to principles of this disclosure may be embodied other than as specifically described herein. The invention is also defined in the following claims, and equivalents thereof.

What is claimed is:

1. A system, comprising:
a memory, and
a hashing circuit,
wherein the hashing circuit is configured to calculate a hash value based on a received data set, the received data set being included in one or more received memory write commands.

2. The system of claim 1, wherein the hashing circuit is further configured to store the hash value in one or more memory-mapped locations.

3. The system of claim 2, wherein the memory-mapped locations are one or more memory-mapped registers in the hashing circuit.

4. The system of claim 2, wherein the memory-mapped locations are one or more memory locations in the memory.

5. The system of claim 2, wherein the hash value is further based on an initial value stored in the one or more memory-mapped locations.

6. The system of claim 5, wherein the one or more memory-mapped locations are externally read-only.

7. The system of claim 2, comprising a Serial Peripheral Interface memory module comprising the memory and the hashing circuit.

8. The system of claim 7 comprising:
a printed circuit board;
a baseboard management controller on the printed circuit board; and
a plurality of Serial Peripheral Interface memory modules, comprising the Serial Peripheral Interface memory module, on the printed circuit board,
wherein the baseboard management controller is configured:
to send the one or more write commands, including a transmitted data set, to the Serial Peripheral Interface memory module,
to calculate a comparison value based on the transmitted data set,
to read the hash value from the one or more memory-mapped locations, and
to compare the hash value and the comparison value.

9. The system of claim 8, wherein:
the baseboard management controller is further configured:
to read an initial value from the one or more memory-mapped locations before sending the one or more write commands; and
to calculate a comparison value further based on the initial value.

10. The system of claim 8, further comprising a plurality of computing circuits on the printed circuit board, each computing circuit being:
connected to a respective Serial Peripheral Interface memory module of the Serial Peripheral Interface memory modules, and
configured to read instructions from the respective Serial Peripheral Interface memory module.

11. The system of claim 1, wherein the memory and the hashing circuit are part of a single semiconductor chip.

12. The system of claim 1, wherein the hashing circuit comprises a linear feedback shift register.

13. The system of claim 1, wherein the received data set includes an address for each write operation and a value for each write operation.

14. A method, comprising:
calculating, by a hashing circuit connected to a memory, a hash value based on a received data set, the received data set being included in one or more received memory write commands.

15. The method of claim 14, further comprising storing the hash value in one or more memory-mapped locations.

16. The method of claim 15, wherein the memory-mapped locations are one or more memory-mapped registers in the hashing circuit.

17. The method of claim 15, wherein the memory-mapped locations are one or more memory locations in the memory.

18. The method of claim 15, wherein the hash value is further based on an initial value stored in the one or more memory-mapped locations.

19. The method of claim 18, wherein the one or more memory-mapped locations are externally read-only.

20. A system, comprising:
a memory, and
a means for hashing,
wherein the means for hashing is configured to calculate a hash value based on a received data set, the received data set being included in one or more received memory write commands.
